(19) United States
(12) Patent Application Publication
(10) Pub. No.: US 2026/0244489 A1
(43) Pub. Date: Aug. 20, 2026

(54) Multi-core Completion Notifications

(71) Applicant: NVIDIA CORPORATION, Santa Clara, CA (US)

(72) Inventors: Petrus Gootzen, Zwolle (NL); Khaled Hamidouche, Austin, TX (US); Roman Nudelman, Danville, CA (US); Salvatore Di Girolamo, Schlieren (CH); Manjunath Gorentla Venkata, San Ramon, CA (US)

(21) Appl. No.: 19/058,051

(22) Filed: Feb. 20, 2025

(51) Int. Cl. G06F 9/48

(52) U.S. Cl. CPC G06F 9/4881

(57) ABSTRACT

In one embodiment, a target system, includes a network interface to receive packets from at least one initiator, packet processing circuitry to process the packets according to work requests stored in a receive queue in memory, generate completion notifications responsively to completing processing of corresponding ones of the work requests, and spray the completion notifications of a given queue pair among different completion queues for processing by corresponding processing cores.

### FIELD OF THE DISCLOSURE

The present disclosure relates to computer systems, and in particular, but not exclusively to, multi-core receiver processing.

### BACKGROUND

In modern data centers and high-performance computing systems, Remote Direct Memory Access (RDMA) technology plays a pivotal role in enabling efficient, low-latency data transfers between computing devices. RDMA allows a system (the initiator) to send data directly to the memory of a remote system (the target), bypassing the need for host central processing units (CPUs) to handle the data movement, thereby enhancing performance by reducing CPU load and minimizing latency.

The initiator in an RDMA-enabled system typically employs a software layer running on a host (e.g., a server or computing node) to initiate RDMA operations. Through an Application Programming Interface (API), this software calls the network interface controller (NIC) of the initiator to transfer data directly to a target device, which may include a NIC embedded with a processor, a host processor (e.g., CPU or graphics processing unit (GPU)), or a specialized processor, such as a Data Processing Accelerator (DPA), integrated within the NIC.

The target device in an RDMA operation may support different processing models, either one-sided or two-sided. In a one-sided RDMA operation, the target device does not require any explicit processing; the initiator sends the data, and the operation completes without the target taking action. In contrast, a two-sided RDMA operation involves the target device receiving a notification, typically in the form of a completion notification, after the data transfer is completed. Upon receiving the completion notification, the target device may perform additional processing or take further actions based on the data received, such as updating memory locations or performing computations.

In an RDMA system, work requests are used to define the operations that need to be performed on the NIC of the initiator and in some cases (e.g., for some RDMA commands), the target application generates work requests detailing operations to be performed on the NIC of the target. Upon completion of processing a work request, a NIC posts a completion notification to a completion queue, which serves as a notification mechanism to inform the host device of the operation's status.

The process typically involves the NIC on the sender side processing work requests stored in a send queue and the NIC on the receiver side processing work requests stored in a receive queue. The queues may reside in host memory or, in some instances, in the NIC's memory. While the NIC handles the completion of the work, the processor (either in the NIC or in the host device) is responsible for polling the completion queue to determine whether any completion notifications are available for processing.

In certain implementations, the memory locations where data is written, associated with the work requests, may include buffer regions in memory on the target device. The RDMA packets associated with these work requests are used to transfer data, which the processor of the target device will subsequently act upon, based on the information provided in the completion notification.

### OVERVIEW

There is provided in accordance with an embodiment of the present disclosure, a target system, including a network interface to receive packets from at least one initiator, packet processing circuitry to process the packets work requests stored in a receive queue in memory, generate completion notifications responsively to completing processing of corresponding ones of the work requests, and spray the completion notifications of a given queue pair among different completion queues for processing by corresponding processing cores.

Further in accordance with an embodiment of the present disclosure, the system includes a memory to store the receive queue and the completion queues, and the processing cores to process the completion notifications from corresponding ones of the completion queues.

Still further in accordance with an embodiment of the present disclosure the processing cores are to poll the corresponding ones of the completion queues for the completion notifications.

Additionally in accordance with an embodiment of the present disclosure the network interface, packet processing circuitry, the memory and the processing cores are disposed in a network interface controller device.

Moreover, in accordance with an embodiment of the present disclosure the processing cores include central processing units (CPUs) and/or graphics processing units (GPUs), the network interface and the packet processing circuitry are disposed in a network interface controller device, the memory and the processing cores are disposed in a host device to share data with the network interface controller device via a data communication bus.

Further in accordance with an embodiment of the present disclosure a single processing core is to update the work requests and update the receive queue for the given queue pair such that the receive queue is not updated by any other processing core for the given queue pair.

Still further in accordance with an embodiment of the present disclosure each one processing core of the processing cores is to update respective ones of the work requests in the receive queue based on identification of the respective work requests in the completion notifications processed by the one processing core.

Additionally, in accordance with an embodiment of the present disclosure the packet processing circuitry is to spray the completion notifications among the completion queues based on output of a function.

Moreover, in accordance with an embodiment of the present disclosure input of the function includes any one or more of the following states of a network device, states of the given queue pair, states of the completion queues, one or more values residing in memory, or states of the packets.

Further in accordance with an embodiment of the present disclosure the packet processing circuitry is to spray the completion notifications among the completion queues based on metadata added to the packets by at least one sender of the packets.

Still further in accordance with an embodiment of the present disclosure the packet processing circuitry is to spray the completion notifications among the completion queues based on a round robin method.

Additionally, in accordance with an embodiment of the present disclosure the packet processing circuitry is to spray the completion notifications among the completion queues based on an occupancy of the completion queues.

Moreover, in accordance with an embodiment of the present disclosure the receive queue is a shared receive queue, which is shared by multiple queue pairs.

There is also provided in accordance with another embodiment of the present disclosure, a method, including receiving packets from at least one initiator, processing the packets work requests stored in a receive queue in memory, generating completion notifications responsively to completing processing of corresponding ones of the work requests, and spraying the completion notifications of a given queue pair among different completion queues for processing by corresponding processing cores.

Further in accordance with an embodiment of the present disclosure, the method includes storing the receive queue and the completion queues, and processing the completion notifications from corresponding ones of the completion queues.

Still further in accordance with an embodiment of the present disclosure, the method includes polling the corresponding ones of the completion queues for the completion notifications.

Additionally, in accordance with an embodiment of the present disclosure, the method includes updating by a single processing core the work requests, and updating by the single processing core the receive queue for the given queue pair such that the receive queue is not updated by any other processing core for the given queue pair.

Moreover, in accordance with an embodiment of the present disclosure, the method includes updating by each one processing core of the processing cores respective ones of the work requests in the receive queue based on identification of the respective work requests in the completion notifications processed by the one processing core.

Further in accordance with an embodiment of the present disclosure, the method includes spraying the completion notifications among the completion queues based on output of a function.

Still further in accordance with an embodiment of the present disclosure input of the function includes any one or more of the following states of a network device, states of the given queue pair, states of the completion queues, one or more values residing in memory, or states of the packets.

Additionally in accordance with an embodiment of the present disclosure, the method includes spraying the completion notifications among the completion queues based on metadata added to the packets by at least one sender of the packets.

Moreover, in accordance with an embodiment of the present disclosure, the method includes spraying the completion notifications among the completion queues based on a round robin method.

Further in accordance with an embodiment of the present disclosure, the method includes spraying the completion notifications among the completion queues based on an occupancy of the completion queues.

### BRIEF DESCRIPTION OF THE DRAWINGS

The present disclosure will be understood from the following detailed description, taken in conjunction with the drawings in which:

FIG. 1 illustrates a block diagram of a computer system constructed and operative in accordance with an embodiment of the present disclosure;

FIG. 2A-B illustrate a block diagram showing operation of a packet processing system, according to aspects of the present disclosure;

FIG. 3 is a flowchart including steps in a method of operation of the system of FIG. 1, in accordance with example embodiments;

FIG. 4 illustrates a flowchart for processing completion notifications, according to aspects of the present disclosure;

FIG. 5 illustrates a block diagram of a computing system, according to an embodiment of the present disclosure; and

FIG. 6 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### DEFINITIONS

A queue pair is a logical data structure used in high-performance networking systems, such as Remote Direct Memory Access (RDMA), to manage communication between an initiator (sender) and a target (receiver) device. It consists of two primary components: a send queue, which is a queue that holds work requests from the initiator; and a receive queue, which is a queue that holds work requests from the target, typically for receiving data or performing memory operations. The queue pair coordinates the sending and receiving of data between two devices, organizing communication tasks and ensuring they are processed in the correct order. It enables low-latency, efficient communication by allowing operations to be posted by the initiator and processed by the target, with completion notifications typically managed through associated completion queues.

A receive queue refers to a data structure used in a networked system, typically in the context of RDMA operations, that holds work requests (e.g., work queue entries (WQEs)) destined for a target device, such as a network interface controller (NIC), processor (e.g., CPU, GPU), or a data processing accelerator (DPA). The receive queue serves as a buffer or queue where work requests are stored by the target device for processing. The primary purpose of the receive queue is to store and organize the work requests that the target device must process. Work requests in the receive queue define operations to be performed by the target device, including memory locations, data transfer operations, and other processing instructions. The receive queue ensures that incoming requests are handled in an ordered manner, allowing the system to manage and execute tasks efficiently.

The receive queue typically resides in memory, which may be located on a device (including a CPU and/or GPU), e.g., on a host device, attached to the NIC, or the NIC itself, depending on the system configuration. The memory space allocated for the receive queue can vary in size based on system requirements and the expected workload. The queue can be implemented as a linked list or other suitable data structure that allows for efficient storage and retrieval of work requests.

Each work request typically contains metadata that specifies any one or more of the following: whether the operation is related to a read, write, or other data transfer action; the target memory address to which data should be transferred or from which data should be read; and pointers to data buffers or other relevant structures necessary for the operation.

The NIC or target device processes the work requests stored in the receive queue in the order they are received, typically in a First-In, First-Out (FIFO) manner. When a work request is processed, the device performs the associated action, such as transferring data to the specified memory location and/or performing a computation. Once the work described in the work request is complete, the corresponding completion notification (e.g., completion queue entry (CQE)) is generated and posted to a completion queue, signaling the completion of the operation.

For example, in response to receiving a new RDMA message from the initiator, the target NIC checks the receive queue for a new work request. The work request is retrieved from the receive queue and processed. After processing, the corresponding completion notification is posted, and the processor may then poll the completion queue for the status of completed operations. The polling mechanism ensures that the target device can track and respond to the completion of each operation in the receive queue.

Completion queue refers to a data structure to store completion notifications that provide status information regarding the completion of operations performed on the target device. The completion queue's primary function is to store and manage the completion status of operations initiated by the NIC. When an operation is completed, the corresponding completion notification is posted to the completion queue to notify the system, specifically the processor, about the completion of a previously issued work request.

The completion queue is typically a circular queue or similar data structure that resides in memory, which may be located on a device (including a CPU and/or GPU), e.g., on a host device, attached to the NIC, or the NIC itself, depending on the system configuration. The memory allocated for the completion queue must be large enough to accommodate the entries corresponding to the expected number of operations being processed. The structure is designed to be efficient in handling the posting of completion notifications without causing delays or blocking other operations.

Each completion notification typically contains metadata that indicates the result of an operation and may include: a completion status that indicates whether the operation was successful or encountered an error, and may be represented as a success flag or error code; an operation type that identifies the type of operation that was completed (e.g., read, write, or other data transfer operations); a work request reference that associates the completion notification with the specific work request that initiated the operation, the reference typically being a pointer or identifier that links the completion notification to the corresponding work item in the receive queue; and optionally transferred data information such as the amount of data transferred, the memory address involved, or any other relevant metadata related to the operation's completion.

The completion queue serves as the notification mechanism for the completion of RDMA operations. When the processor or host polls the completion queue and retrieves a completion notification, it gains information about the outcome of the associated operation. This can be used to trigger follow-up actions, such as: releasing resources associated with the completed operation; updating system status or performance metrics; and performing additional operations based on the outcome (e.g., retrying failed transfers or triggering other data processing tasks).

In RDMA systems, the completion queue is tightly integrated with the processing of work requests. The target NIC processes work requests from the receive queue and, upon completion, posts the corresponding completion notification to the completion queue. The completion of the operation and the posting of the completion notification occur independently of the initiator, allowing the initiator to continue its tasks while waiting for the completion notification. This decoupling helps improve performance by enabling efficient parallel processing and reducing idle time for both the initiator and target device.

A shared receive queue is a specialized data structure used in high-performance networking systems, such as RDMA, where multiple queue pairs (e.g., multiple connections, to possibly multiple distinct target processes or NICs) are combined into a single shared receive queue that a single entity may utilize. Each queue pair's operations are processed by the target device as though they were using a dedicated receive queue, but the actual receive queue is shared. The target processor submits work requests for (all) the queue pairs to the shared receive queue. These work requests define the operations to be performed by the target device, such as data transfers, memory access, or other processing tasks. By centralizing the receive operations in a single queue, the shared receive queue helps reduce the overhead of managing multiple-separate receive queues. It also improves load balancing, as multiple queue pairs can access and process work entries from the same queue, allowing for better distribution of tasks and efficient use of available resources.

### OVERVIEW OF EXAMPLE EMBODIMENTS

In modern data centers and high-performance computing systems, efficient processing of network packets across multiple processing cores presents a significant challenge. In multicore systems, it is desired to load balance processing of the completion notifications among the multiple processing cores.

One solution is to assign one core to read the completion queue and assign the completion notifications to the other cores for processing. Another solution is to assign different queue pairs to different cores. Both these solutions lead to sub-optimal utilization of resources.

Embodiments of the present disclosure address the drawbacks by distributing or “spraying” completion notifications among completion queues assigned to corresponding processing cores so that each processing core processes the completion notifications in the completion queue assigned to that processing core. The spraying may be performed using any suitable method such as based on a function output, based on initiator tagging, based on round robin, or assigning a completion notification to the completion queue currently storing the least number of completion notifications.

In some embodiments, a target system receives packets from one or more initiators and processes these packets using multiple processing cores. The target system may include a network interface to receive the packets and packet processing circuitry to handle the incoming data. In some cases, the target system may incorporate a data processing accelerator (DPA) integrated within a network interface controller to enhance processing capabilities.

The packet processing circuitry may process the received packets according to work requests stored in a receive queue in memory. As the processing of each work request is completed, the packet processing circuitry generates completion notifications.

Instead of directing all completion notifications to a single completion queue, the packet processing circuitry sprays the completion notifications of a given queue pair across multiple completion queues. Each of these completion queues is associated with a corresponding processing core, allowing for parallel processing of the completion notifications.

This spraying technique may be implemented using various methods. In some cases, the packet processing circuitry may spray the completion notifications based on the output of a function. This function may take into account various inputs such as the states of a network device, the states of queue pairs, the states of completion queues, or the states of the packets themselves.

Another method may involve spraying the completion notifications based on tagging (e.g., metadata added to) the packets by the sender or senders of the packets. This approach allows for sender-directed distribution of processing tasks across the target system's cores.

In some implementations, a round-robin method may be employed to distribute the completion notifications evenly among the completion queues. Alternatively, the packet processing circuitry may consider the occupancy of the completion queues when deciding where to place each completion notification, potentially leading to more balanced processing loads across the cores.

The receive queue used in this system may be a shared receive queue, which can be shared by multiple queue pairs. This sharing of the receive queue allows for efficient use of memory resources while still enabling the distribution of completion notifications across multiple completion queues.

By spraying completion notifications across multiple queues and processing cores, this approach may enable more efficient utilization of multi-core processors in network packet processing tasks. This technique may lead to improved load balancing, reduced processing latency, and enhanced overall system performance in high-performance computing environments.

### SYSTEM DESCRIPTION

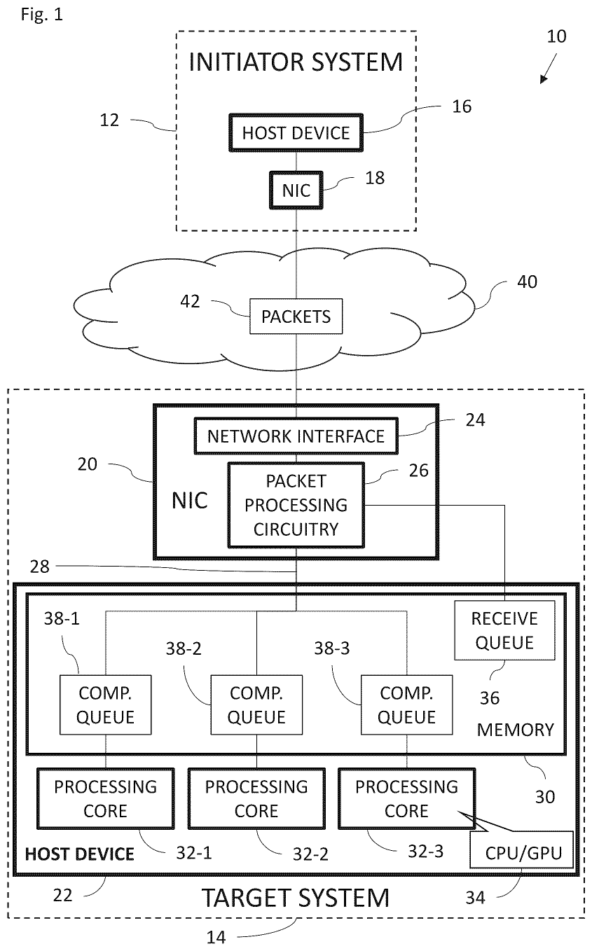

FIG. 1 illustrates a block diagram of a computer system 10 for processing network packets 42. The computer system 10 may include an initiator system 12 and a target system 14 connected through a network 40.

The initiator system 12 may comprise an initiator host device 16 connected to an initiator NIC 18 via a data communication bus. The initiator NIC 18 may transmit packets 42 over the network 40 to the target system 14.

The target system 14 may include a target NIC 20 and a target host device 22. The target NIC 20 may include a network interface 24 that receives the packets 42, and packet processing circuitry 26 that processes the received packets 42. The packet processing circuitry 26 may connect to memory 30 via a data communication bus 28.

In some cases, the network interface 24 and the packet processing circuitry 26 may be disposed in a network interface controller device, such as the target NIC 20. The memory 30 and processing cores may be disposed in the target host device 22 to share data with the target NIC 20 via the data communication bus 28.

The memory 30 may include a receive queue 36 and multiple completion queues, including a first completion queue 38-1, a second completion queue 38-2, and a third completion queue 38-3. Three completion queues are shown by way of example in FIG. 1. Any suitable number of completion queues may be used. The target system 14 may include the memory 30 to store the receive queue 36 and the completion queues 38-1, 38-2, and 38-3. In some cases, the receive queue 36 may be a shared receive queue, which is shared by multiple queue pairs.

The target host device 22 may include multiple processing cores such as a first processing core 32-1, a second processing core 32-2, and a third processing core 32-3. Three processing cores are shown in FIG. 1 by way of example. Any suitable number of processing cores may be used. Each processing core may be implemented as a CPU or GPU 34. Each processing core may connect to its corresponding completion queue - the first processing core 32-1 to the first completion queue 38-1, the second processing core 32-2 to the second completion queue 38-2, and the third processing core 32-3 to the third completion queue 38-3.

The processing cores 32-1, 32-2, and 32-3 may process the completion notifications from corresponding ones of the completion queues 38-1, 38-2, and 38-3. In some cases, the processing cores 32-1, 32-2, and 32-3 may communicate via an NVLink interconnect or any suitable interconnect.

The packet processing circuitry 26 may process incoming packets 42 according to work requests stored in the receive queue 36 and generate completion notifications that may be distributed or “sprayed” among the completion queues 38-1, 38-2, and 38-3 for processing by their respective processing cores 32-1, 32-2, and 32-3.

In some implementations, the network 40 may include packet switches that may comprise Nvidia Quantum-2 switches. The network interface controllers, such as the target NIC 20, may comprise Nvidia Bluefield DPUs in some cases.

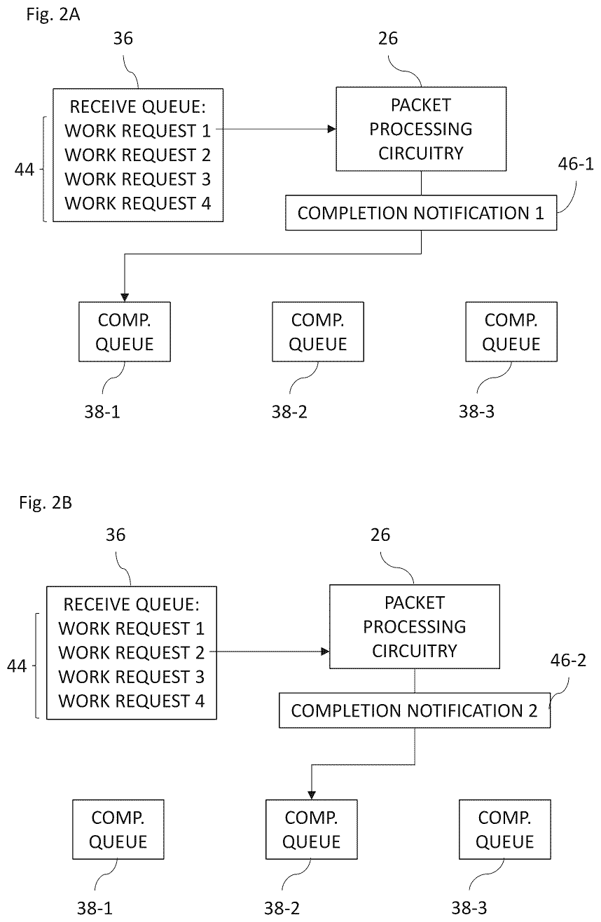

Reference is now made to FIG. 2A-2B. FIGS. 2A and 2B illustrate block diagrams showing the operation of packet processing in system 10 of FIG. 1. The receive queue 36 includes work requests 44 generally added to the receive queue 36 by an application running on the host device 22. The packet processing circuitry 26 is configured to process the work requests 44.

In FIG. 2A, the packet processing circuitry 26 generates a first completion notification 46-1 in response to processing work request 1. The first completion notification 46-1 is added to the first completion queue 38-1.

In FIG. 2B, the packet processing circuitry 26 generates a second completion notification 46-2 in response to processing work request 2. The second completion notification 46-2 is added to the second completion queue 38-2.

FIGS. 2A and 2B demonstrate how completion notifications may be distributed or “sprayed” among different completion queues. The packet processing circuitry 26 may process the work requests 44 from the receive queue 36 and generate completion notifications that may be distributed or “sprayed” among the three completion queues 38-1, 38-2, and 38-3.

In some cases, the packet processing circuitry 26 may spray the completion notifications among the completion queues based on output of a function. The input of the function may include any one or more of the following: states of a network device such as the target NIC 20; states of a given queue pair; states of the completion queues 38-1, 38-2, and 38-3; one or more values residing in memory; or states of the packets 42. The output of the function is indicative of the completion queue to which the completion notification should be written.

The following are examples of ways of configuring the function or an algorithm to determine which completion queues to spray the completion notification to and/or how many completion queues are to be used.

For example, the function may be configured so that if the NIC 20 is under internal memory pressure (which can negatively impact performance), the output of the function may yield fewer completion queues so that NIC 20 can unload the memory of the not-utilized completion queues.

For example, if an application (e.g., running on host device 22) informs the NIC 20 that it can provide a completion notification consumption rate of X million packets per second (Mpps), the function may be configured so that the output of the function yields a number of utilized completion queues in the spraying according to the message rate of the queue pair. So, if for example, the queue pair currently has a message rate of 3X Mpps, the spraying function sprays among three completion queues.

For example, the function may be configured such that the count of bytes transferred is used to determine the completion queue to spray to, with the aim of giving each completion queue an equal share of the bytes transferred within a certain period. This may be useful in bandwidth bound applications.

For example, if NIC 20 has to generate three completion notifications of sizes 1 MB, 512 KB and 512 KB, the function may be configured to spray the first completion notification of 1 MB to one completion queue, and the other two completion notifications of 512 KB each to a second completion queue, so that both completion queues have 1 MB of data to process.

For example, the function may implement a simple round-robin until the occupancy of one of the completion queues rises above X % of the occupancy of one of the other completion queues, and then switch to any other method of spraying.

One or more values residing in memory (residing on memory accessible by the NIC via an interconnect) may be used as input to the spraying function or algorithm. A CPU, GPU or DPA may periodically write to a memory address that includes a heuristic used by the function or algorithm. For example, each core may have a memory address where it writes whether it is currently able to be part of the completion notification spraying (i.e., receive more completion notifications for processing). If the core has to unexpectedly perform additional work on a completion notification, that core may notify the NIC that it wants to be excluded from receiving additional completion notifications at present to prevent a load imbalance from occurring.

In some implementations, the packet processing circuitry 26 may spray the completion notifications among the completion queues based on tagging (i.e., metadata added to) the packets 42 by sender(s) of the packets 42. This metadata may be added by the initiator system 12 or the initiator NIC 18 before transmitting the packets 42 over the network 40.

In some implementations, the packet processing circuitry 26 may spray the completion notifications among the completion queues based on a round-robin method. For example, completion notification 1 is sprayed to completion queue 38-1, completion notification 2 is sprayed to completion queue 38-2, completion notification 3 is sprayed to completion queue 38-3, completion notification 4 is sprayed to completion queue 38-1, completion notification 5 is sprayed to completion queue 38-2, and so on.

In some implementations, the packet processing circuitry 26 may spray the completion notifications among the completion queues based on occupancy of the completion queues. For example, the packet processing circuitry 26 is configured to select the completion queue with the lowest occupancy and then spray the next completion notification to the completion queue with the lowest occupancy.

The spraying of completion notifications may allow for efficient load balancing among the processing cores 32-1, 32-2, and 32-3. Each processing core may process the completion notifications from its corresponding completion queue, potentially leading to improved overall system performance. For example, processing core 32-1 processes the completion notifications in completion queue 38-1, processing core 32-2 processes the completion notifications in completion queue 38-2, and processing core 32-3 processes the completion notifications in completion queue 38-3, and so on.

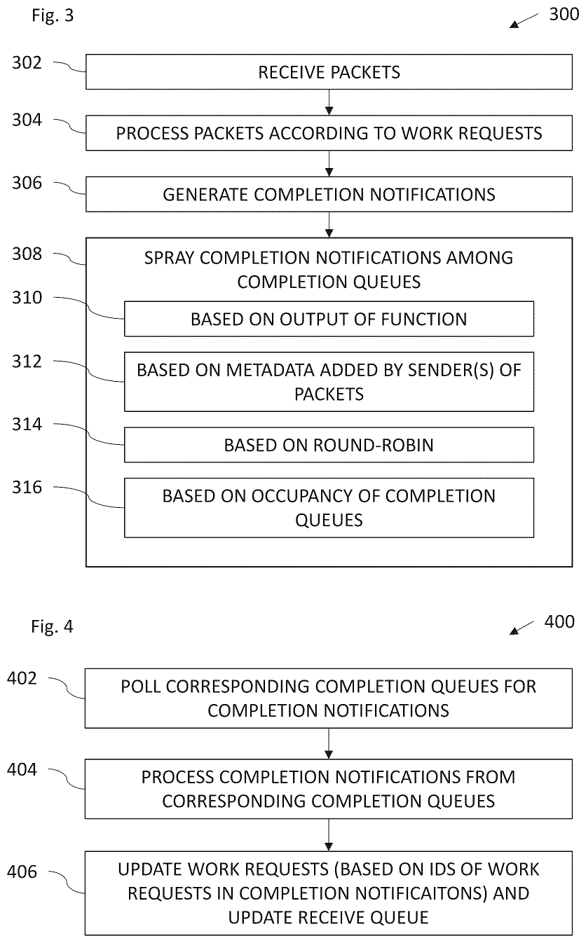

Reference is now made to FIG. 3. The packet processing circuitry 26 may execute a process for managing packets and completion notifications. A flowchart 300 may illustrate this process. The flowchart 300 may include multiple steps for handling incoming packets and distributing completion notifications.

The flowchart 300 begins with step 302 of receiving the packets 42 from the initiator system 12. The network interface 24 may perform this step, accepting incoming data from the network 40.

Following the receipt of the packets 42, step 304 may involve processing the packets 42 according to the work requests 44 stored in the receive queue 36 in the memory 30. The packet processing circuitry 26 may execute this step, interpreting and acting upon the instructions contained in the work requests 44.

Upon completing the processing of the work requests 44, step 306 may involve generating completion notifications. The packet processing circuitry 26 may generate the completion notifications to indicate the successful execution of the corresponding work requests 44.

Step 308 may involve spraying the completion notifications of a given queue pair among the different completion queues. This distribution may allow for processing by the corresponding processing cores. The packet processing circuitry 26 may perform this spraying step using various methods described below with reference to steps 310-316.

One method for spraying the completion notifications, represented by step 310, may involve basing the distribution on the output of a function (e.g., a hash function which hashes the contents of the packet). This function may consider various inputs to determine the appropriate completion queue for each notification.

The inputs to this function may include any one or more of the following: states of the target NIC 20; states of the given queue pair; states of the first completion queue, the second completion queue, and the third completion queue; or states of the packets. By considering these factors, the function may aim to optimize the distribution of completion notifications.

Another method, represented by a step 312, may involve spraying based on metadata added to the packets by the initiator system 12. This approach may allow the sender to influence the distribution of processing tasks across the target system's cores.

Step 314 may represent a method of spraying based on a round-robin approach. This method aims to distribute the completion notifications evenly among the completion queues.

Step 316 may represent a method of spraying based on the occupancy of the completion queues. This approach may consider the current workload of each queue when deciding where to place new completion notifications.

By employing these various methods for spraying completion notifications, the packet processing circuitry 26 may aim to achieve efficient load balancing among the processing cores. This distribution of tasks may contribute to improved overall performance of the target system in handling network communications.

Reference is now made to FIG. 4. The target system may employ a process for handling completion notifications, which may be illustrated by a flowchart 400. The flowchart 400 may include multiple steps for managing the completion notifications and updating the work requests.

Step 402 of the flowchart 400 may involve the processing cores polling corresponding completion queues, e.g., first completion queue 38-1, second completion queue 38-2, and third completion queue 38-3 for the completion notifications. The first processing core 32-1, the second processing core 32-2, and the third processing core 32-3 may perform this polling operation of their respective completion queues. In some cases, the processing cores may continuously, periodically, or intermittently, check their associated completion queues for new completion notifications.

Step 404 may involve processing the completion notifications by the processing cores from the corresponding completion queues, e.g., first completion queue 38-1, second completion queue 38-2, and third completion queue 38-3 for the completion notifications. The first processing core 32-1, the second processing core 32-2, and the third processing core 32-3 may execute this step, handling the completion notifications retrieved from their respective completion queues, first completion queue 38-1, second completion queue 38-2, and third completion queue 38-3. Processing the completion notifications may include interpreting the information contained within each notification and taking appropriate actions based on that information.

Step 406 may involve updating the work requests based on identification of the respective work requests in the completion notifications processed by the processing cores. For example, the identity of work request 1 may be include in completion notification 1. In some cases, each processing core may update respective work requests in the receive queue 36. For example, if processing core 32-1 processed completion notification 1, then processing core update work request 1, and if processing core 32-2 processed completion notification 2, then processing core update work request 2, and so on. This updating may be based on the identification of the respective work requests in the completion notifications processed by each processing core.

In some implementations, a single assigned processing core may be responsible for updating all the work requests in the receive queue 36 and updating the receive queue 36 for a given queue pair. This approach may ensure that the receive queue 36 is not updated by any other processing core for the given queue pair, potentially avoiding conflicts or inconsistencies in the receive queue management. The process of updating the receive queue 36 may involve updating a value in memory called a doorbell record. The doorbell record may contain a producer index, which may indicate the point in the queue up to which the target application has placed valid work requests.

In some cases, even though each processing core updates its work requests based on the completion notifications processed by that processing core, a single assigned processing core may be responsible for updating the receive queue 36 for a given queue pair.

In some implementations, the processing core which updates its work requests based on the completion notifications processed by that processing core may update the receive queue 36. Each completion queue (e.g., the first completion queue, the second completion queue, and the third completion queue) may have its own copy of the receive queue doorbell record. When updating work requests, the processing cores may simply update the work requests and then write that work queue element's index into the doorbell record of the corresponding completion queue. The packet processing circuitry 26 may then determine which of these several doorbell records contains the effective producer index by taking the minimum of all the producer indices.

This approach to handling completion notifications and updating work requests may allow for efficient utilization of the multiple processing cores in the target system. By distributing the processing of completion notifications across the first processing core, the second processing core, and the third processing core, etc. and employing strategies to manage the receive queue effectively, the target system may achieve improved performance in handling network communications.

In some embodiments, each core receives a completion notification, processes the completion notification, and updates its corresponding completion queue. Updating the completion queue may include writing the new completion queue consumer index to the completion queue doorbell record, corresponding to the last completion notification index that was just consumed by the target application, and if the target application wants to receive an event and/or interrupt in the future, rearming the completion queue via the completion queue doorbell register.

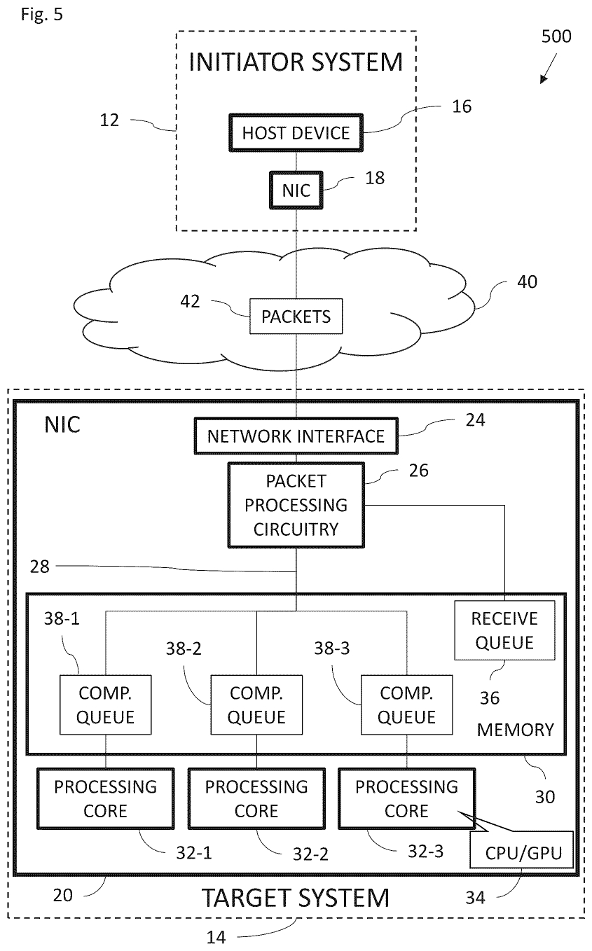

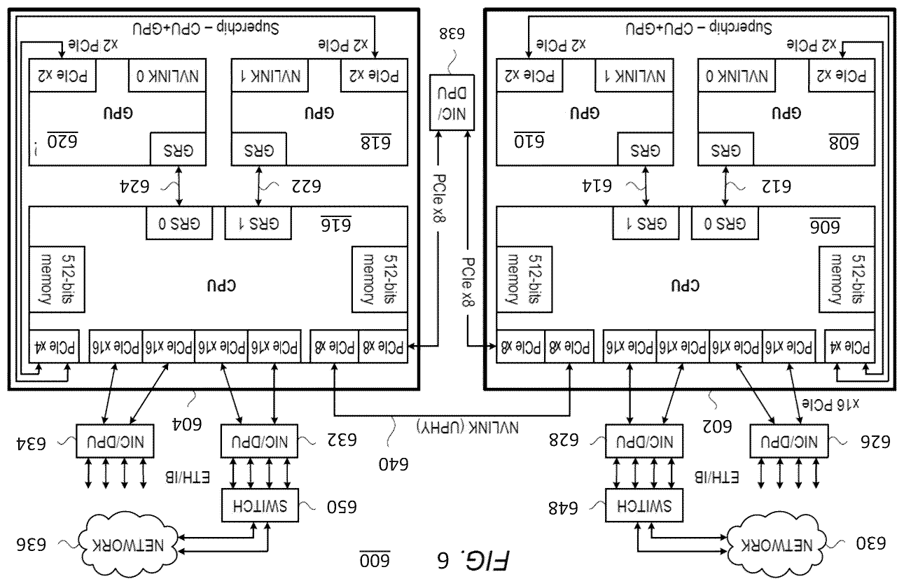

FIG. 5 illustrates a block diagram of a computing system 500. The computing system 500 may be substantially the same as the computer system 10 of FIG. 1, except for the location of the memory 30 and the processing cores 32-1, 32-2, 32-3, are within the target NIC 20.

In the computing system 500, the target NIC 20 may contain the network interface 24, the packet processing circuitry 26, the memory 30, and the processing cores 32-1, 32-2, 32-3. Specifically, the first processing core 32-1, the second processing core 32-2, and the third processing core 32-3 may be disposed within the target NIC 20, rather than in the target host device 22 as shown in FIG. 1.

The memory 30 within the target NIC 20 may store the receive queue 36, the first completion queue 38-1, the second completion queue 38-2, and the third completion queue 38-3, and so on. This arrangement may allow for direct access to the queues by the packet processing circuitry 26 and the processing cores without the need to communicate over the data communication bus 28. This configuration may potentially reduce latency in processing the packets 42 and handling the work requests 44, as all components involved in packet processing and completion notification management may be located within the same device. The processing cores in the target NIC 20 may be implemented as a CPU or GPU 34, similar to the arrangement in FIG. 1.

The operation of the computing system 500 may be similar to that described for the computer system 10 in FIG. 1. The network interface 24 may receive the packets 42 from the initiator system 12 via the network 40. The packet processing circuitry 26 may process these packets 42 according to the work requests 44 stored in the receive queue 36 in the memory 30.

As the packet processing circuitry 26 completes processing of the work requests 44, the packet processing circuitry 26 may generate completion notifications, such as the first completion notification 46-1 and the second completion notification 46-2. These completion notifications may be sprayed among the first completion queue 38-1, the second completion queue 38-2, and the third completion queue 38-3, which may be processed by the corresponding first processing core 32-1, second processing core 32-2, and third processing core 32-3, respectively.

The integration of all these components within the target NIC 20 may potentially allow for more efficient processing of network packets and management of completion notifications, as the data may not need to traverse the data communication bus 28 to reach the processing cores or the memory 30.

Reference is now made to FIG. 6, which is a block diagram that schematically illustrates a computing system 600, e.g., a data center or a High-Performance Computing (HPC) cluster, in accordance with an embodiment of the present disclosure.

System 600 comprises a plurality of subsystems, e.g., multiple processing devices coupled to each other, multiple network devices, and multiple networks, according to at least one embodiment. Computing system 600 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 600 and to one or more external networks 630, 636. In the present example, system 600 comprises a packet switch 648 that connects NIC/DPU 628 to network 630, and a packet switch 650 that connects NIC/DPU 632 to network 636.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 600 can include one or more CPUs and one or more GPUs.

FIG. 6 also demonstrates an example architecture of a multi-GPU architecture. As illustrated in the figure, computing system 600 includes a processing device 602 with a multi-GPU architecture. In particular, processing device 602 may be a system-on-chip and includes multiple subsystems such as a CPU 606, a GPU 608, and a GPU 610. CPU 606 can be coupled to GPU 608 via a die-to-die (D2D) or chip-to-chip (C2C) interconnect 612, such as a Ground-Referenced Signaling interconnect (GRS interconnect). CPU 606 can be coupled to GPU 610 via a D2D or C2C interconnect 614. CPU 606 can also couple to GPU 608 and GPU 610 via PCIe interconnects.

CPU 606 can be coupled to one or more NICs or DPUs, which are coupled to one or more networks. For example, as illustrated in FIG. 6, CPU 606 is coupled to a first NIC/DPU 626, which is coupled to a network 630. CPU 606 is also coupled to a second NIC/DPU 628, which is coupled to network 630 via switch 648. NIC/DPU 626 and NIC/DPU 628 can be coupled to network 630 over Ethernet (ETH), NVLINK or InfiniBand (IB) connections, for example.

Computing system 600 also includes a processing device 604 with a multi-GPU architecture. In particular, processing device 604 includes multiple subsystems including a CPU 616, a GPU 618, and a GPU 620. CPU 616 can be coupled to GPU 618 via a D2D or C2C interconnect 622. CPU 616 can be coupled to GPU 620 via a D2D or C2C interconnect 624. CPU 616 can also couple to GPU 618 and GPU 620 via PCIe interconnects. CPU 616 can be coupled to one or more NICs or DPUs, which are coupled to one or more networks. For example, as illustrated in FIG. 6, CPU 616 is coupled to a first NIC/DPU 632, which is coupled to a network 636. CPU 616 is also coupled to a second NIC/DPU 634, which is coupled to network 636 via switch 650. NIC/DPU 632 and NIC/DPU 634 can be coupled to network 636 over Ethernet (ETH), NVLINK or InfiniBand (IB) connections.

In at least one embodiment, processing device 602 and processing device 604 can communicate with each other via a NIC/DPU 638, such as over PCIe interconnects. Processing device 602 and processing device 604 can also communicate with each other over a high-bandwidth communication interconnect 640, such as an NVLink interconnect or other high-speed interconnects. The packet switches in FIG. 6 may comprise, for example, Nvidia Quantum-2 switches. The NICs/DPUs in the figure may comprise, for example, Nvidia Bluefield DPUs.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The flowchart and block diagrams in the Figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form “a”, “an” and “the” include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A target system, comprising:
a network interface to receive packets from at least one initiator;
packet processing circuitry to:
process the packets according to work requests stored in a receive queue in memory;
generate completion notifications responsively to completing processing of corresponding ones of the work requests; and
spray the completion notifications of a given queue pair among different completion queues for processing by corresponding processing cores.

2. The system according to claim 1, further comprising:
a memory to store the receive queue and the completion queues; and
the processing cores to process the completion notifications from corresponding ones of the completion queues.

3. The system according to claim 2, wherein the processing cores are to poll the corresponding ones of the completion queues for the completion notifications.

4. The system according to claim 2, wherein the network interface, packet processing circuitry, the memory and the processing cores are disposed in a network interface controller device.

5. The system according to claim 2, wherein:
the processing cores include central processing units (CPUs) and/or graphics processing units (GPUs);
the network interface and the packet processing circuitry are disposed in a network interface controller device;
the memory and the processing cores are disposed in a host device to share data with the network interface controller device via a data communication bus.

6. The system according to claim 2, wherein a single processing core is to update the work requests and update the receive queue for the given queue pair such that the receive queue is not updated by any other processing core for the given queue pair.

7. The system according to claim 2, wherein each one processing core of the processing cores is to update respective ones of the work requests in the receive queue based on identification of the respective work requests in the completion notifications processed by the one processing core.

8. The system according to claim 1, wherein the packet processing circuitry is to spray the completion notifications among the completion queues based on output of a function.

9. The system according to claim 8, wherein input of the function includes any one or more of the following: states of a network device; states of the given queue pair; states of the completion queues; one or more values residing in memory; or states of the packets.

10. The system according to claim 1, wherein the packet processing circuitry is to spray the completion notifications among the completion queues based on metadata added to the packets by at least one sender of the packets.

11. The system according to claim 1, wherein the packet processing circuitry is to spray the completion notifications among the completion queues based on a round-robin method.

12. The system according to claim 1, wherein the packet processing circuitry is to spray the completion notifications among the completion queues based on an occupancy of the completion queues.

13. The system according to claim 1, wherein the receive queue is a shared receive queue, which is shared by multiple queue pairs.

14. A method, comprising:
receiving packets from at least one initiator;
processing the packets according to work requests stored in a receive queue in memory;
generating completion notifications responsively to completing processing of corresponding ones of the work requests; and
spraying the completion notifications of a given queue pair among different completion queues for processing by corresponding processing cores.

15. The method according to claim 14, further comprising:
storing the receive queue and the completion queues; and
processing the completion notifications from corresponding ones of the completion queues.

16. The method according to claim 15, further comprising polling the corresponding ones of the completion queues for the completion notifications.

17. The method according to claim 15, further comprising:
updating by a single processing core the work requests; and
updating by the single processing core the receive queue for the given queue pair such that the receive queue is not updated by any other processing core for the given queue pair.

18. The method according to claim 15, further comprising updating by each one processing core of the processing cores respective ones of the work requests in the receive queue based on identification of the respective work requests in the completion notifications processed by the one processing core.

19. The method according to claim 14, further comprising spraying the completion notifications among the completion queues based on output of a function.

20. The method according to claim 19, wherein input of the function includes any one or more of the following: states of a network device; states of the given queue pair; states of the completion queues; one or more values residing in memory; or states of the packets.

21. The method according to claim 14, further comprising spraying the completion notifications among the completion queues based on metadata added to the packets by at least one sender of the packets.

22. The method according to claim 14, further comprising spraying the completion notifications among the completion queues based on a round-robin method.

23. The method according to claim 14, further comprising spraying the completion notifications among the completion queues based on an occupancy of the completion queues.
